(19) United States
(12) Patent Application Publication
(10) Pub. No.: US 2024/0168423 A1
(43) Pub. Date: May 23, 2024

(54) IMAGE FORMING APPARATUS AND NON-TRANSITORY COMPUTER READABLE MEDIUM STORING PROGRAM

(71) Applicant: FUJIFILM Business Innovation Corp., Tokyo (JP)

(72) Inventors: Yutaka KIUCHI, Kanagawa (JP); Shigeru Arai, Kanagawa (JP); Yuma Motegi, Kanagawa (JP); Ko Umenai, Kanagawa (JP)

(73) Assignee: FUJIFILM Business Innovation Corp., Tokyo (JP)

(21) Appl. No.: 18/329,023

(22) Filed: Jun. 5, 2023

(30) Foreign Application Priority Data
Nov. 18, 2022 (JP) 2022-185253

(51) Int. Cl. G03G 15/00; G03G 15/16

(52) U.S. Cl. CPC G03G 15/505; G03G 15/162; G03G 15/55

(57) ABSTRACT

An image forming apparatus includes: a transporter including a gripper to grip a recording medium; an image former that forms a developer image on a transfer body; a transferrer that transfers the developer image to the recording medium by bringing the transfer body with the developer image formed into contact with a transfer cylinder having space to store the gripper; and a processor configured to: correct a density of the developer image formed in the image former, using information related to speed variation of the transfer body when the developer image is transferred to the recording medium, so that density unevenness in an image formed on the recording medium is reduced.

### CROSS-REFERENCE TO RELATED APPLICATIONS

This application is based on and claims priority under 35 USC 119 from Japanese Patent Application No. 2022-185253 filed Nov. 18, 2022.

### BACKGROUND

### (i) Technical Field

The present disclosure relates to an image forming apparatus and a non-transitory computer readable medium storing a program.

### (ii) Related Art

Japanese Unexamined Patent Application Publication No. 2020-140062 discloses an image forming apparatus including: an annular transfer belt; a transfer cylinder that transfer a toner image formed on the transfer belt to a recording medium; a rotating body disposed at both axial ends of the transfer cylinder; a circumferentially moving member that is wound over the rotating body, and circumferentially moves by the rotation of the rotating body; and a holding unit mounted on the circumferentially moving member to hold a recording medium, and transports the recording medium by circumferential movement of the circumferentially moving member.

In addition, Japanese Unexamined Patent Application Publication No. 2007-140402 discloses a technique for correcting density unevenness which occurs in an image after a toner image formed on a transfer belt is transferred to a recording medium.

### SUMMARY

In order to improve paper transport performance, an image forming apparatus has been proposed, which grips and transports paper by a gripper, and transfers a toner image on a transfer belt to paper on a transfer cylinder having a gripper storage space by bringing the toner image into contact with the paper.

In such an image forming apparatus, vibration is caused by a collision between the corner of the gripper storage space of the transfer cylinder and the transfer belt, then speed variation occurs in the transfer belt, and as a result, density unevenness occurs in a printed image.

A technique is known which performs density correction in opposite phase to density unevenness with a constant cycle in an image, caused by roller deflection of a transfer belt.

However, with this technique, it is not possible to correct density unevenness in an image caused by unexpected vibration with no constant period, such as the above-mentioned vibration caused by a collision between the corner of the gripper storage space of the transfer cylinder and the transfer belt.

Aspects of non-limiting embodiments of the present disclosure relate to providing an image forming apparatus and a non-transitory computer readable medium storing a program that are capable of correcting density unevenness in an image caused by unexpected vibration.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including: a transporter including a gripper to grip a recording medium; an image former that forms a developer image on a transfer body; a transferrer that transfers the developer image to the recording medium by bringing the transfer body with the developer image formed into contact with a transfer cylinder having space to store the gripper; and a processor configured to: correct a density of the developer image formed in the image former, using information related to speed variation of the transfer body when the developer image is transferred to the recording medium, so that density unevenness in an image formed on the recording medium is reduced.

### BRIEF DESCRIPTION OF THE DRAWINGS

Exemplary embodiment of the present disclosure will be described in detail based on the following figures, wherein:

FIG. 1 is a schematic view illustrating the configuration of an image forming apparatus according to an exemplary embodiment of the present disclosure;

FIG. 2 is a perspective view illustrating the configuration of a transferrer according to the exemplary embodiment of the present disclosure;

FIG. 3 is a perspective view illustrating the configuration of a fixing device according to the exemplary embodiment of the present disclosure;

FIG. 4 is a perspective view illustrating a gripper according to the exemplary embodiment of the present disclosure;

FIG. 5 is a block diagram illustrating the hardware configuration of the image forming apparatus;

FIG. 6 is a block diagram illustrating the functional configuration of the image forming apparatus;

FIG. 7 is view illustrating a state in which a contact position with an opposed roller in a transfer cylinder is an upstream corner of a recess;

FIG. 8 is view illustrating a state in which a contact position with an opposed roller in a transfer cylinder is a downstream corner of a recess;

FIGS. 9A and 9B are graphs showing a relationship between a speed variation of a transfer belt and a density variation in a toner image formed on a recording medium, FIG. 9A is a graph showing a speed variation rate of a transfer belt, and FIG. 9B is a graph showing a density variation rate of a toner image;

FIGS. 10A and 10B are graphs showing a relationship between a speed variation of a transfer belt and a density correction pattern, FIG. 10A is a graph showing a speed variation rate of a transfer belt, and FIG. 10B is a graph showing a density correction pattern;

FIG. 11 is a flowchart showing a process at the time of density correction in the image forming apparatus;

FIGS. 12A and 12B are graphs showing a relationship between a speed variation of a transfer belt and a density correction function, FIG. 12A is a graph showing a speed variation rate of a transfer belt, and FIG. 12B is a graph showing only characteristics during an event occurrence period in the graph showing the speed variation rate of the transfer belt; and

FIG. 13 is a flowchart showing a process at the time of density correction in the image forming apparatus according to a modification.

### DETAILED DESCRIPTION

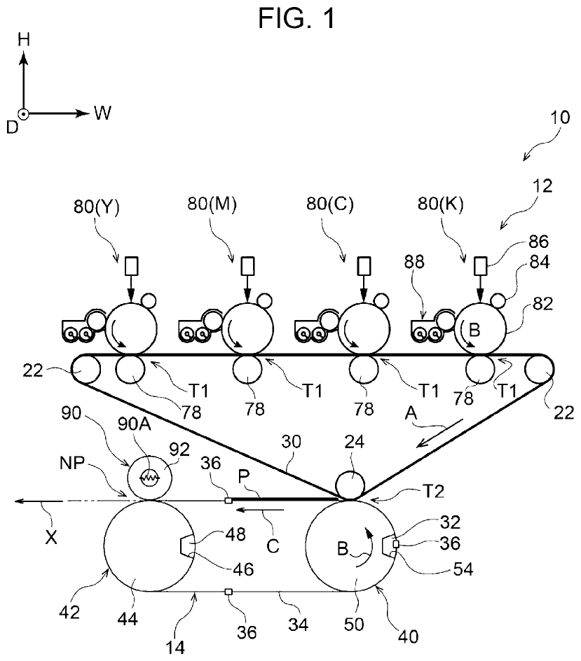

Hereinafter, an exemplary embodiment of the present disclosure will be described in detail with reference to the drawings. Note that for the sake of explanation, the direction along arrow H illustrated in FIG. 1 indicates a height direction of an image forming apparatus 10, the direction along arrow W indicates a width direction of the image forming apparatus 10, and the direction along arrow D indicates a depth direction of the image forming apparatus 10.

The image forming apparatus 10 in the exemplary embodiment is an apparatus that forms a toner image as an example of a developer image on a recording medium P by an electrophotographic system, and includes an image former 12, a transporter 14, and a fixing device 90 as illustrated in FIG. 1.

Hereinafter, the image former 12, the transporter 14, and the fixing device 90 of the image forming apparatus 10 will be described.

### (Image Former 12)

As illustrated in FIG. 1, the image former 12 as an example of an image former has a function of forming a toner image on a recording medium P. Specifically, the image former 12 includes a transfer belt 30 as an example of a transfer body, two rollers 22, an opposed roller 24, toner image formers 80 that form respective color toner images, and a transferrer 40.

The transfer belt 30 is formed in an endless shape, and is wound around the two rollers 22 and the opposed roller 24 so as to have an outline of an inverted triangle shape as seen in the depth direction. The transfer belt 30 is formed in a belt shape, and configured to circumferentially move in arrow A direction by at least one of the two rollers 22 being rotationally driven.

Each color toner image former 80 (80Y, 80M, 80C, 80K) has a cylindrical photoconductor 82 that rotates in one direction (arrow B direction), and a charging device 84, an exposure device 86, and a developing device 88 are disposed around each photoconductor 82 in that order from upstream in the rotational direction of the photoconductor 82.

In each color toner image former 80, the charging device 84 charges the surface of the photoconductor 82, and the exposure device 86 exposes the surface of the photoconductor 82 charged by the charging device 84 to form an electrostatic latent image on the surface of the photoconductor 82. The developing device 88 forms a toner image by developing the electrostatic latent image formed on the surface of the photoconductor 82 by the exposure device 86.

Note that on the inner peripheral surface of the transfer belt 30, first transfer rollers 78 opposed to the photoconductors 82 are provided with the transfer belt 30 interposed therebetween. The toner images formed by respective color toner image formers 80 are first transferred and layered onto the transfer belt 30 successively at first transfer positions T1 where first transfer rollers 78 are provided, and the layered toner images are second transferred to a recording medium P at a second transfer position T2.

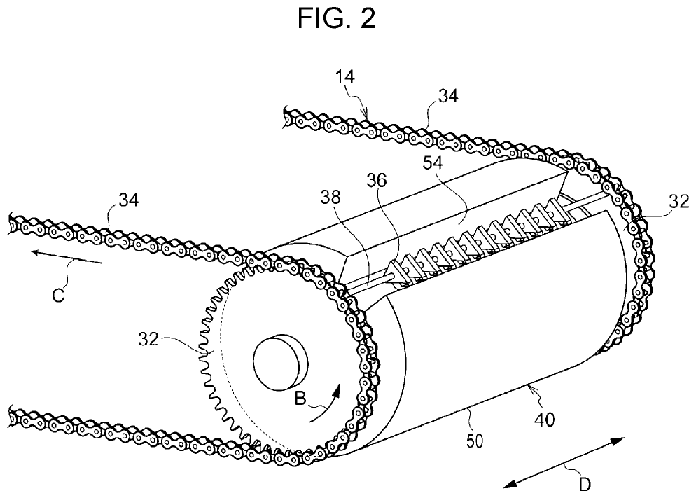

The transferrer 40 is disposed below the transfer belt 30. As illustrated in FIG. 2, the transferrer 40 has a transfer cylinder 50 that is disposed to be coaxial with the axial direction of the opposed roller 24. The transfer cylinder 50 is disposed to be opposed to the transfer belt 30, and forms the second transfer position T2 at which the transfer belt 30 is interposed between the transfer cylinder 50 and the opposed roller 24. In other words, the opposed roller 24 forms the second transfer position T2 by pressing the transfer belt 30 from the inner side.

In the exemplary embodiment, a toner image is transported to the second transfer position T2 by the circumferential movement of the transfer belt 30, and a recording medium P is transported to the second transfer position T2 by the transporter 14. The transfer cylinder 50 pressurizes the recording medium P and the toner image transported to the second transfer position T2 by nipping them between the transfer cylinder 50 and the transfer belt 30, thereby transferring the toner image onto the recording medium P.

Note that the transport direction of a recording medium P is indicated by arrow X in FIG. 1. Also, when a recording medium P and a toner image are nipped and pressed between the transfer belt 30 and the transfer cylinder 50 at the second transfer position T2, the recording medium P and the toner image may be heated by the transfer cylinder 50. In part of the outer peripheral surface of the transfer cylinder 50, a recess 54 is formed which is a space for storing the later-described gripper 36 and support member 38.

The configuration of the transferrer 40 in the exemplary embodiment will be described with reference to the perspective view of FIG. 2. As illustrated in FIG. 2, a pair of sprockets 32 are provided at both axial ends of the transfer cylinder 50. The pair of sprockets 32 are disposed to be coaxial with the transfer cylinder 50, and configured to rotate integrally with the transfer cylinder 50. The transfer cylinder 50 is configured to be rotationally driven by a driver (not illustrated). Chains 34 are wound around the pair of sprockets 32.

Note that the opposed roller 24 is configured to be movable between a contact position for contact with the transfer cylinder 50 and a separate position for separation from the transfer cylinder 50 using a movement mechanism (not illustrated) for transfer, such as a cam. Specifically, the opposed roller 24 is always urged to the contact position, for example, by an elastic force of an elastic member such as a spring, and is configured to be moved to the separate position against the elastic force by the movement mechanism for transfer.

As described above, the transfer cylinder 50 has an approximately circular cross section, and the recess 54 for storing the gripper 36 is provided in a direction approximately perpendicular to the rotational direction. The transfer cylinder 50 transfers an image on the transfer belt 30 onto a recording medium P transported by the transporter 14 by nipping the recording medium P between the transfer belt 30 and itself. Note that approximately perpendicular indicates a state in which the angle formed by two directions is in a range of 85 to 95 degrees.

### (Fixing Device 90)

As illustrated in FIG. 1, the fixing device 90 is a device that fixes a toner image transferred to a recording medium P onto the recording medium P. Specifically, the fixing device 90 has a pressurizer 42, and a heating roller 92 disposed downstream in the transport direction of the recording medium P in the transporter 14.

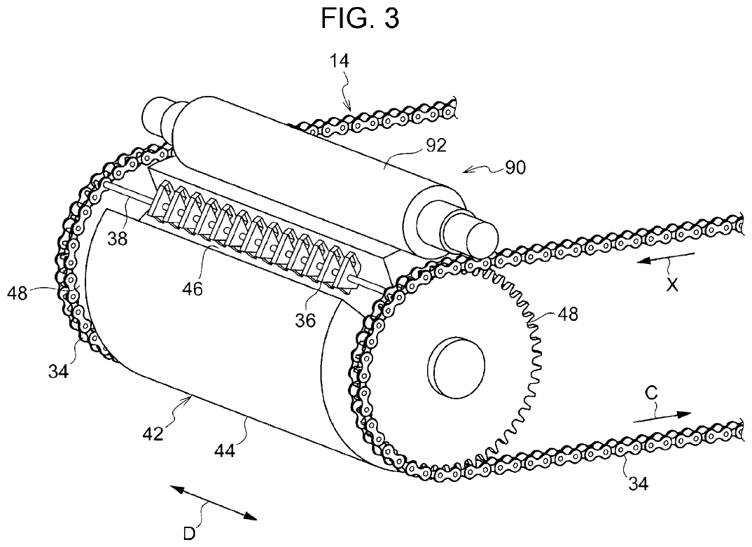

The configuration of the fixing device 90 in the exemplary embodiment will be described with reference to the perspective view of FIG. 3. As illustrated in FIG. 3, the pressurizer 42 has a pressure roller 44 disposed to be coaxial with the transfer cylinder 50, and a pair of sprockets 48 are provided at both axial ends of the pressure roller 44. The pair of sprockets 48 are disposed to be coaxial with the pressure roller 44, and configured to rotate integrally with the pressure roller 44. The above-mentioned chains 34 are wound around the pair of sprockets 48, respectively.

As illustrated in FIG. 1, the heating roller 92 and the pressure roller 44 are disposed side by side vertically. Specifically, the heating roller 92 is disposed above the pressure roller 44. The heating roller 92 internally has a heating source 90A (see FIG. 1) such as a halogen lamp. Note that in the following, let nip position NP be the position at which a recording medium P is nipped between the heating roller 92 and the pressure roller 44.

Note that the heating roller 92 is configured to be movable between a contact position for contact with the pressure roller 44 and a separate position for separation from the pressure roller 44 using a movement mechanism (not illustrated) for fixing, such as a cam. Specifically, the heating roller 92 is always urged to the contact position, for example, by an elastic force of an elastic member such as a spring, and is configured to be moved to the separate position against the elastic force by the movement mechanism for fixing. In addition, the heating roller 92 is configured to nip a recording medium P between the pressure roller 44 and itself at the contact position.

Note that in the exemplary embodiment, the heating roller 92 is configured to be rotationally driven, and the pressure roller 44 is configured to be driven to rotate; however, both the heating roller 92 and the pressure roller 44 may be configured to be rotationally driven. In part of the outer peripheral surface of the pressure roller 44, a recess 46 is formed for storing the later-described gripper 36 and support member 38.

### (Transporter 14)

As illustrated in FIG. 1 to FIG. 3, the transporter 14 has a function of transporting a recording medium P and passing it through the second transfer position T2 and the nip position NP. The transporter 14 has the pair of chains 34 and the gripper 36. The pair of chains 34 is an example of a driving force transmission member, and the gripper 36 is an example of a gripper that grips the leading end of a recording medium P. Note that in FIG. 1, the chains 34 and the gripper 36 are illustrated in a simplified manner. In this manner, the transporter 14 transports a recording medium P with the leading end thereof gripped by the gripper.

As illustrated in FIG. 1, the pair of chains 34 are formed in a circular shape. As illustrated in FIG. 2 and FIG. 3, the pair of chains 34 are disposed at an interval in an apparatus depth direction. Specifically, the pair of chains 34 are wound around the pair of sprockets 32 provided coaxially with the transfer cylinder 50, and the pair of sprockets 48 provided coaxially with the pressure roller 44.

When the transfer cylinder 50 is rotationally driven by a driver which is not illustrated, the pair of sprockets 32 are also rotationally driven in rotational direction B (arrow B direction) integrally with the transfer cylinder 50, and the chains 34 circumferentially move in circumferential direction C (arrow C direction). Thus, the pressure roller 44 is driven to rotate. Specifically, the rotational driving force of the transfer cylinder 50 is transmitted to the pressure roller 44 by the pair of chains 34 which circumferentially move in the circumferential direction C (see FIG. 1).

As illustrated in FIG. 2 and FIG. 3, the support member 38 in which the gripper 36 is disposed is passed over the pair of chains 34 along the apparatus depth direction. In the exemplary embodiment, the pair of chains 34 are provided with three support members 38, which are fixed to the pair of chains 34 at a predetermined interval along the circumferential direction C (arrow C direction) of the chains 34.

Multiple grippers 36 are mounted next to each support member 38 at predetermined intervals along the apparatus depth direction. In other words, the grippers 36 are mounted on the chains 34 via the support member 38. Each of the grippers 36 has a hold function of holding the leading end of a recording medium P.

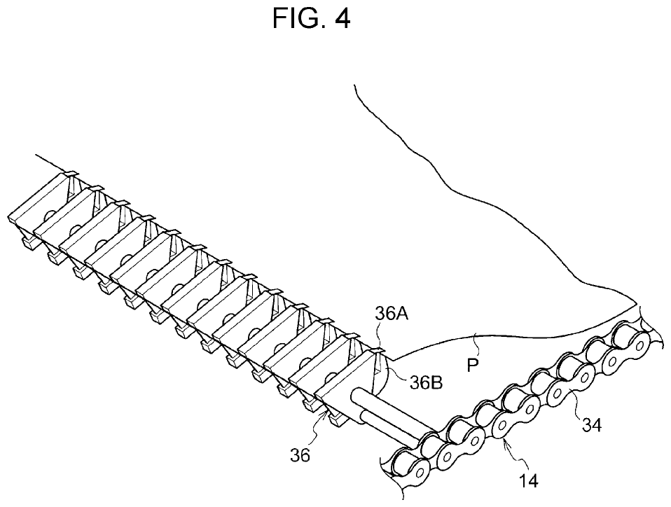

Specifically, as illustrated in FIG. 4, the gripper 36 has a plurality of nails 36A and a plurality of nail bases 36B. The gripper 36 is configured to hold a recording medium P by gripping the leading end of the recording medium P between the nails 36A and the nail bases 36B.

Also, the gripper 36 is configured to hold the leading end of the recording medium P at a position downstream in the transport direction of the recording medium P. Note that the gripper 36 is configured so that for example, the nails 36A are pressed against the nail bases 36B by a spring or the like, and the nails 36A are separated from the nail bases 36B by an operation of a cam or the like.

In this manner, in the transporter 14, the leading end of a recording medium P delivered from a storage (not illustrated) is held by the gripper 36. Also, the transporter 14 transports the recording medium P by moving the gripper 36 by circumferential movement of the chains 34 in the circumferential direction C with the leading end of the recording medium P held by the gripper 36, thus the recording medium P passes through the second transfer position T2 along with the gripper 36 with the recording medium P held by the gripper 36.

Note that the pair of chains 34 each have a length which is an integral multiple of the outer circumferences of the sprockets 32 in the transferrer 40 and the sprockets 48 in the pressurizer 42. The three support members 38 are provided at locations corresponding to the positions, on the chains 34, of the recess 54 of the transfer cylinder 50 and the recess 46 of the pressure roller 44. Thus, when reaching the transfer cylinder 50 while moving along with the circumferential movement of the chains 34, the gripper 36 moves integrally with the transfer cylinder 50 with the gripper 36 stored in the recess 54 of the transfer cylinder 50. Similarly, when reaching the pressure roller 44, the gripper 36 moves integrally with the pressure roller 44 with the gripper 36 stored in the recess 46 of the pressure roller 44.

Here, the transporter 14 in the exemplary embodiment is configured to transport a recording medium P to the nip position NP in a state where the heating roller 92 is at the separate position, while holding the leading end of the recording medium P by the gripper 36. The transporter 14 is configured to, upon transporting a recording medium P to the nip position NP, release the holding of the leading end of the recording medium P.

In other words, the transporter 14 is configured to, after passing of the gripper 36 through the nip position NP, release the holding of the leading end of the recording medium P. Note that the pressure roller 44 is configured to maintain a rotating state, in other words, a circumferentially moving state of the chains 34.

Also, transport of a recording medium P to the nip position NP is detected in terms of the elapsed time since detection of the leading end of the recording medium P, for example, by a detector provided upstream of the nip position NP in the transport direction. Note that the detection target of the detector may not be the leading end of the recording medium P, and may be the support member 38 or the gripper 36.

The heating roller 92 is configured to, after passing of the gripper 36 through the nip position NP and releasing the hold of the leading end of a recording medium P by the gripper 36, start to move from the separate position to the contact position, and nip the recording medium P transported to the nip position NP with the pressure roller 44. The heating roller 92 is configured to start to rotate and transport the recording medium P with the recording medium P nipped between the heating roller 92 and the pressure roller 44.

Note that the heating roller 92 may start to move from the separate position to the contact position before releasing the hold of the leading end of the recording medium P by the gripper 36, and after releasing the hold of the leading end of the recording medium P by the gripper 36, nipping of the recording medium P between the heating roller 92 and the pressure roller 44 may be completed.

In this manner, the fixing device 90 is configured to fix a toner image transferred to a recording medium P onto the recording medium P by heating and pressing the recording medium P, while transporting the recording medium P with the recording medium P nipped between the heating roller 92 and the pressure roller 44.

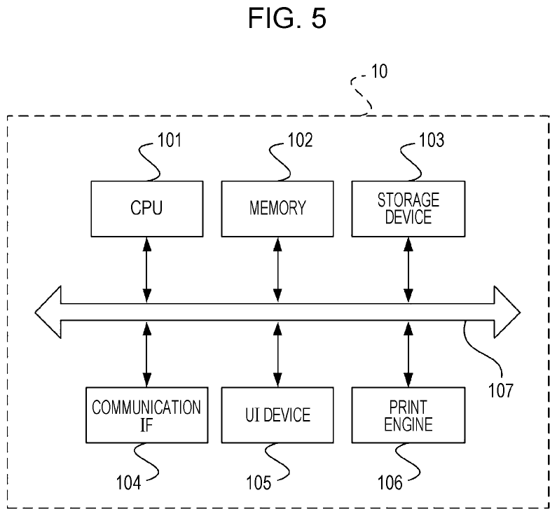

Next, the hardware configuration of the image forming apparatus 10 in the exemplary embodiment will be described. FIG. 5 is a block diagram illustrating the hardware configuration of the image forming apparatus 10.

As illustrated in FIG. 5, the image forming apparatus 10 includes a CPU 101, a memory 102, a storage device 103 such as a hard disk drive, a communication interface (abbreviated as IF) 104 to transmit and receive data to and from an external device via a network, a user interface (abbreviated as UI) device 105 including a touch panel or a liquid crystal display and a keyboard, and a print engine 106. These components are coupled to each other via a control bus 107.

The communication IF 104 transmits and receives data to and from an external device. The UI device 105 receives an instruction input from a user. The print engine 106 is comprised of the image former 12, the transporter 14, and the fixing device 90, and prints an image on the recording medium P by an electrophotographic system.

The CPU 101 is a processor that executes a predetermined process based on a control program stored in the memory 102 or the storage device 103 to control the operation of the image forming apparatus 10. Note that in the exemplary embodiment, the CPU 101 has been described as a processor that reads and executes a control program stored in the memory 102 or the storage device 103; however, the present disclosure is not limited to this. The control program may be provided in a form of a computer-readable recording medium that records the control program. For example, the program may be provided in a form of an optical disk such as a compact disc (CD)-read only memory (ROM) and a digital versatile disc (DVD)-ROM, or a semiconductor memory such as a USB (Universal Serial Bus) memory and a memory card that records the control program. The control program may be obtained from an external device via a communication line connected to the communication IF 104.

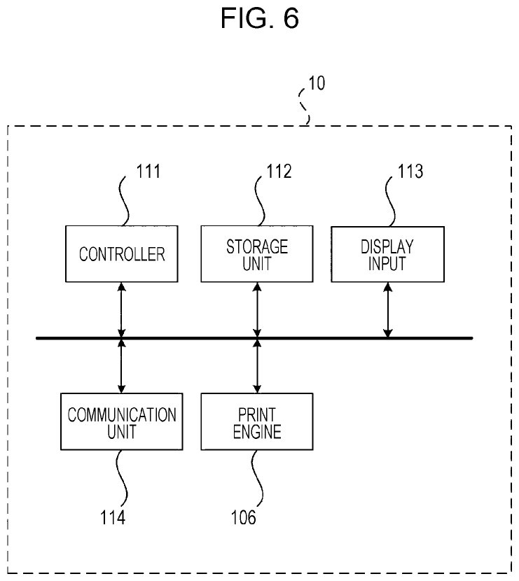

Next, the functional configuration of the image forming apparatus 10 in the exemplary embodiment will be described. FIG. 6 is a block diagram illustrating the functional configuration of the image forming apparatus 10.

As illustrated in FIG. 6, the image forming apparatus 10 includes a controller 111, a storage unit 112, a display input 113, a communication unit 114, and a print engine 106.

The controller 111 controls the entire operation of the image forming apparatus 10, and performs control, for example, on printing of an image by the print engine 106, and correction to the image printed by the print engine 106. Note that the details of correction at the time of image printing will be described later.

In addition to the control program, the storage unit 112 stores various data such as correction data for making the later-described correction at the time of image printing.

The display input 113 displays various information on the display screen of the UI device 105 based on the control of the controller 111. In addition, the display input 113 receives input of various information on operation performed by a user in the UI device 105. The communication unit 114 transmits and receives various data such as image data to and from an external device.

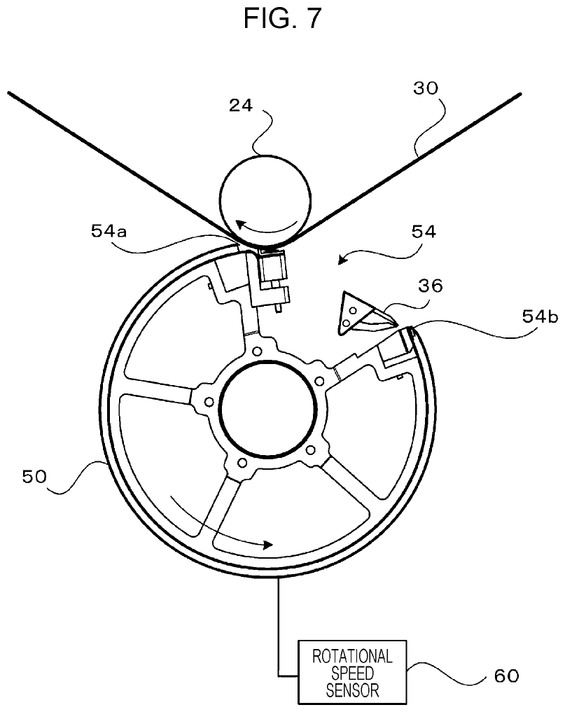

As illustrated in FIG. 7, when the print engine 106 includes the gripper 36 to hold the recording medium P, as described above, the recess 54 is needed in part of the outer peripheral surface of the transfer cylinder 50 as a space for storing the gripper 36.

In the print engine 106, the opposed roller 24 is urged to the transfer cylinder 50. The opposed roller 24 and the transfer cylinder 50 rotate while being in contact with each other with the transfer belt 30 interposed therebetween.

In addition, as illustrated in FIG. 1, the print engine 106 transfers a toner image to a recording medium P by nipping and pressing the recording medium P and the toner image between the transfer cylinder 50 and the transfer belt 30 at the second transfer position T2.

In this situation, with the recess 54 formed in the outer peripheral surface of the transfer cylinder 50, when the contact position with the opposed roller 24 in the transfer cylinder 50 is an upstream corner 54a of the recess 54 as illustrated in FIG. 7, the distance from the center of the transfer cylinder 50 to the outer periphery changes suddenly, and the opposed roller 24 comes into contact with the transfer cylinder 50 with urged against the transfer cylinder 50. As a result, vibration occurs in the print engine 106, and the moving speed of the transfer belt 30 varies.

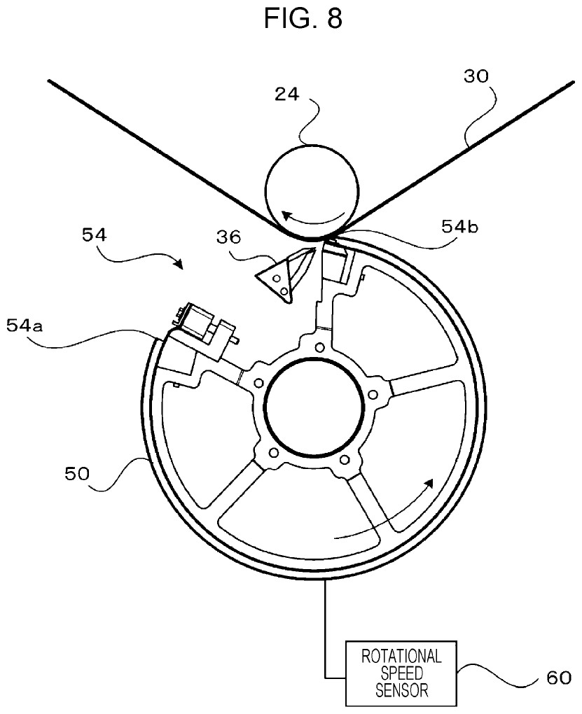

In addition, as illustrated in FIG. 8, also when the contact position with the opposed roller 24 in the transfer cylinder 50 is a downstream corner 54b of the recess 54, the distance from the center of the transfer cylinder 50 to the outer periphery changes suddenly, and the opposed roller 24 comes into contact with the downstream corner 54b of the transfer cylinder 50. As a result, as expected, vibration occurs in the print engine 106, and the moving speed of the transfer belt 30 varies.

Such a vibration occurrence mechanism is applied to the nip position NP at which recording medium P is nipped between the pressure roller 44 having the recess 46, and the heating roller 92. The pressure roller 44 and the transfer cylinder 50 are coupled by a pair of chains 34, thus vibration generated at the nip position NP is transmitted to the transfer belt 30 through the transfer cylinder 50, and the moving speed of the transfer belt 30 varies.

When the moving speed of the transfer belt 30 varies in the print engine 106 at the time of image printing, adverse effect occurs on formation of a toner image in the image former 12, first transfer at the first transfer position T1, and second transfer at the second transfer position T2, thus density unevenness occurs in the toner image formed on the recording medium P.

The controller 111 of the image forming apparatus 10 in the exemplary embodiment corrects the density of a toner image formed in the image former 12 using information related to the speed variation of the transfer belt 30 at the time of transfer of a toner image to the recording medium P so that density unevenness in the image formed on the recording medium P is reduced.

In the exemplary embodiment, the information related to the speed variation of the transfer belt 30 is information based on the detection signal of a rotational speed sensor 60 that detects a rotational speed of the transfer cylinder 50.

Note that the information related to the speed variation of the transfer belt 30 is not limited to the information based on the detection signal of the rotational speed sensor 60 that detects a rotational speed of the transfer cylinder 50, and may be information based on the detection signal of a rotational speed sensor that detects the rotational speed of a component which rotates in conjunction with the transfer belt 30 in the image forming apparatus 10. For example, the information may be based on the detection signal of a rotational speed sensor that detects a rotational speed of the rollers 22 or the opposed roller 24 which are rotating bodies in contact with the transfer belt 30, or a rotational speed sensor that detects a rotational speed of the pressure roller 44.

In addition, the information related to the speed variation of the transfer belt 30 is not limited to the information based on the detection signal of a rotational speed sensor, and any information may be used as long as the information is correlated with the speed variation of the transfer belt 30, such as information from a vibration detection sensor.

Hereinafter, the density correction by the controller 111 will be described in detail.

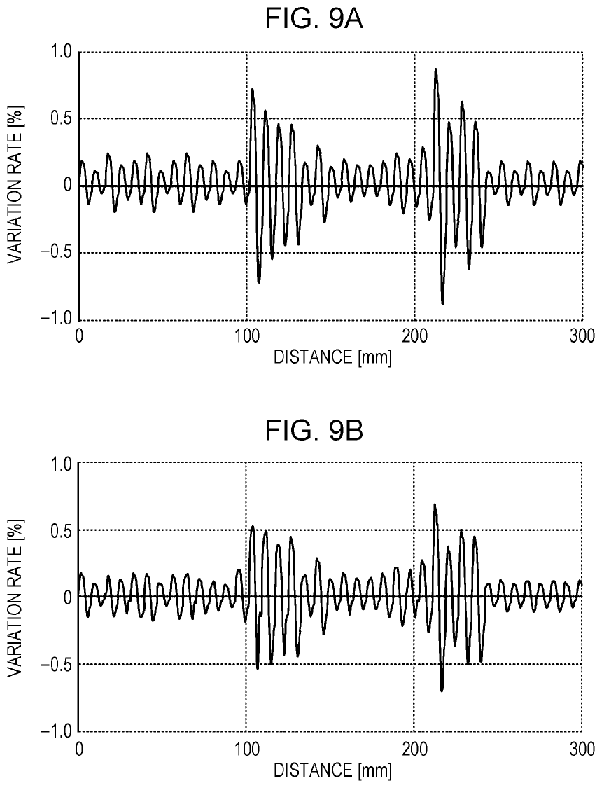

FIGS. 9A and 9B are graphs showing a relationship between the speed variation of the transfer belt 30 and the density variation in a toner image formed on a recording medium P, FIG. 9A is a graph showing the speed variation rate of the transfer belt 30, and FIG. 9B is a graph showing the density variation rate of the toner image.

In the graphs in FIGS. 9A and 9B, the horizontal axis indicates the distance (mm) from the top position of a recording medium P, and the vertical axis indicates the speed of the transfer belt 30 or the variation rate (%) of the density in the toner image.

As illustrated in FIGS. 9A and 9B, the speed variation rate of the transfer belt 30, and the density variation rate of the toner image formed on a recording medium P are correlated with each other. Specifically, in an area of the graph where the speed variation rate of the transfer belt 30 is high, the density variation rate in an image is also high, and conversely, in an area of the graph where the speed variation rate of the transfer belt 30 is low, the density variation rate in an image is also low.

Therefore, when correction is made to the density of a toner image formed in the image former 12 by a density correction pattern with characteristics of reversed positive and negative values of the speed variation rate characteristics of the transfer belt 30, density unevenness in the toner image formed on the recording medium P is leveled, and the density unevenness is less noticeable.

As described above, the pair of chains 34 each have a length which is an integral multiple of the outer circumferences of the sprockets 32 in the transferrer 40 and the sprockets 48 in the pressurizer 42. The three support members 38 are provided at locations corresponding to the positions, on the chains 34, of the recess 54 of the transfer cylinder 50 and the recess 46 of the pressure roller 44.

Thus, the above-described vibration in the recess 54 of the transfer cylinder 50 and the recess 46 of the pressure roller 44 occurs unexpectedly without periodicity at the time of formation of one toner image; however, at the time of formation of multiple toner images, vibration occurs at the same position in each toner image every time.

In other words, at the time of formation of multiple toner images, the speed variation rate characteristics of the transfer belt 30 in the toner images are all the same. Therefore, when the speed variation rate characteristic data of the transfer belt 30 is obtained once, the density of each subsequently formed toner image can be corrected.

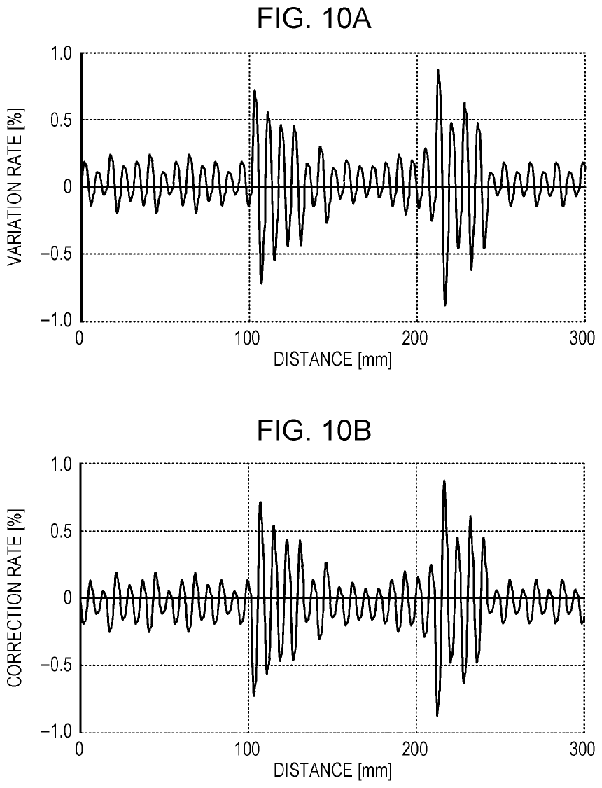

FIGS. 10A and 10B are graphs showing a relationship between the speed variation of the transfer belt 30 and a density correction pattern, FIG. 10A is a graph showing the speed variation rate of the transfer belt 30, and FIG. 10B is a graph showing the density correction pattern. Note that the graph of FIG. 9A and the graph of FIG. 10A are the same.

In the graph of FIG. 10A, the horizontal axis indicates the distance (mm) from the top position of the recording medium P, and the vertical axis indicates the variation rate (%) of the speed of the transfer belt 30. In the graph of FIG. 10B, the horizontal axis indicates the distance (mm) from the top position of the recording medium P, and the vertical axis indicates the correction amount (%) of density correction.

The controller 111 obtains the speed variation rate characteristic data of the transfer belt 30 as illustrated in FIG. 10A in advance based on the detection signal of the rotational speed sensor 60, and stores in the storage unit 112, as correction data, a density correction pattern with characteristics of reversed positive and negative values of the speed variation rate characteristics of the transfer belt 30 as illustrated in FIG. 10B.

Note that the amount of density correction in the density correction pattern is not necessary the same as the variation rate in the characteristics of reversed positive and negative values of the speed variation rate characteristics of the transfer belt 30, and the correction amount may be adjusted by multiplying the density correction pattern by an adjustment coefficient.

When a toner image is formed on a recording medium P, the controller 111 corrects the density of the toner image formed in the image former 12 using a density correction pattern stored in the storage unit 112.

Note that a timing for obtaining the speed variation rate characteristic data of the transfer belt 30 is not particularly limited, and for example, the speed variation rate characteristic data may be obtained before the image forming apparatus 10 is shipped from a factory, or obtained when maintenance work of the image forming apparatus 10 is performed by a service engineer.

For density correction to a toner image formed in the image former 12, image data to form the toner image may be corrected using a density correction pattern so that the density unevenness of the toner image formed on the recording medium P is reduced.

Alternatively, the density unevenness of the toner image formed on the recording medium P may be reduced by correcting the exposure amount in the exposure device 86 of the toner image former 80 using a density correction pattern without correcting the image data.

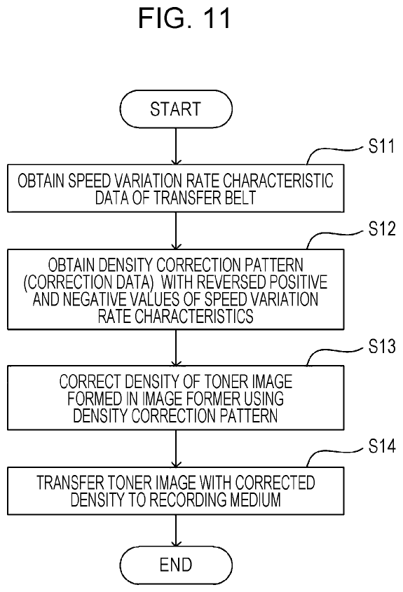

Next, the process at the time of density correction in the image forming apparatus 10 will be described with reference to the flowchart of FIG. 11.

First, in step S11, the controller 111 obtains speed variation rate characteristic data of the transfer belt 30 based on the detection signal of the rotational speed sensor 60.

Next, in step S12, the controller 111 obtains, as correction data, a density correction pattern with characteristics of reversed positive and negative values of the speed variation rate characteristics of the transfer belt 30, and stores the density correction pattern in the storage unit 112.

Next, in step S13, when a toner image is formed on a recording medium P, the controller corrects the density of the toner image formed in the image former 12 using a density correction pattern stored in the storage unit 112.

As described above, the density correction at this point may be made by correcting the image data to form the toner image using a density correction pattern, or by correcting the exposure amount in the exposure device 86 of the toner image former 80 using a density correction pattern.

Finally, in step S14, the controller 111 transfers the toner image with a corrected density to a recording medium P, and completes the process. [Modifications]

Note that in the exemplary embodiment, a density correction pattern with characteristics of reversed positive and negative values of the speed variation rate characteristics of the transfer belt 30 is obtained as correction data, and the density of the toner image formed in the image former 12 is corrected using the density correction pattern; however, the density correction of the toner image is not limited to this aspect, and as long as density correction of the toner image is possible, any aspect may be applied.

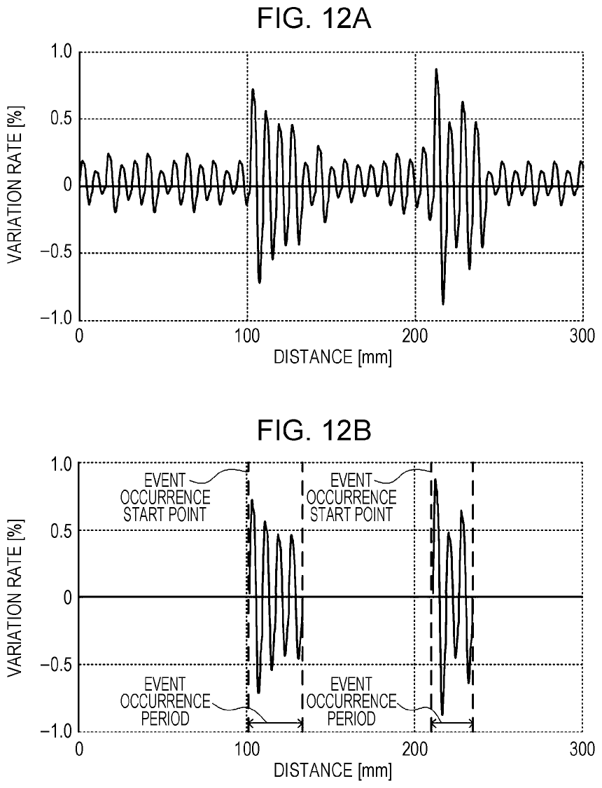

For example, the aspect shown in the following may be applied. FIGS. 12A and 12B are graphs showing a relationship between the speed variation of the transfer belt 30 and a density correction function, FIG. 12A is a graph showing the speed variation rate of the transfer belt 30, and FIG. 12B is a graph showing only characteristics during an event occurrence period in the graph showing the speed variation rate of the transfer belt 30. Note that the graph of FIG. 9A and the graph of FIG. 12A are the same.

In the graph of FIGS. 12A and 12B, the horizontal axis indicates the distance (mm) from the top position of the recording medium P, and the vertical axis indicates the variation rate (%) of the speed of the transfer belt 30.

The controller 111 obtains the speed variation rate characteristic data of the transfer belt 30 as illustrated in FIG. 12A in advance based on the detection signal of the rotational speed sensor 60, and identifies the occurrence start point and the occurrence period of speed variation (hereinafter referred to as an event) which has occurred unexpectedly from the speed variation rate characteristic data as illustrated in FIG. 12B.

As a method of identifying the event occurrence start point from the speed variation rate characteristic data, a position where the speed variation rate exceeds a predetermined threshold in the speed variation rate characteristic data may be identified as an event occurrence start point.

When a toner image is formed on a recording medium P using the rotational speed

sensor 60 provided in the image forming apparatus 10, or using a sensor such as a vibration detection sensor (not illustrated), a position where the speed variation rate or the vibration exceeds a predetermined threshold is physically detected, and an event occurrence start point may be identified by associating the detection result with the speed variation rate characteristic data of the transfer belt 30.

As a method of identifying an event occurrence period from the speed variation rate characteristic data, the period from a position where the speed variation rate exceeds a predetermined threshold to a position where the speed variation rate falls below a predetermined threshold in the speed variation rate characteristic data may be identified as an event occurrence period.

When a toner image is formed on a recording medium P using the rotational speed sensor 60 provided in the image forming apparatus 10, or using a sensor such as a vibration detection sensor (not illustrated), a position where the speed variation rate or vibration exceeds a predetermined threshold and a position where the speed variation rate or vibration falls below a predetermined threshold again are physically detected, and an event occurrence period may be identified by associating the detection result with the speed variation rate characteristic data of the transfer belt 30.

The controller 111 generates a density correction function for each event based on an event occurrence start point and an event occurrence period, and stores the density correction function in the storage unit 112 as correction data.

The density correction function f(x) is represented as follows. Where f(a) is an attenuation function, and f(b) is a basic waveform function to make corrections. The unit for f(x), f(a), f(b) is mm.

f(x)=f(a)×f(b)

The basic waveform function f(b) is a function which approximates the characteristics of reversed positive and negative values of the characteristics during an event occurrence period from an event occurrence start point in the speed variation rate characteristics of the transfer belt 30.

The attenuation function f(a) is a function that defines an attenuation coefficient (a value less than or equal to 1) for adjusting the correction amount defined by the basic waveform function f(b), and has attenuation characteristics such that as the distance from an event occurrence start point increases, the correction amount decreases.

The attenuation function f(a) has, for example, characteristics in which the attenuation coefficient does not change, characteristics in which the attenuation decreases in inverse proportion to the distance, or characteristics in which the attenuation decreases in inverse proportion to square of the distance.

When a toner image is formed on a recording medium P, the controller 111 corrects the density of the toner image formed in the image former 12 using a density correction function f(x) stored in the storage unit 112 for each event.

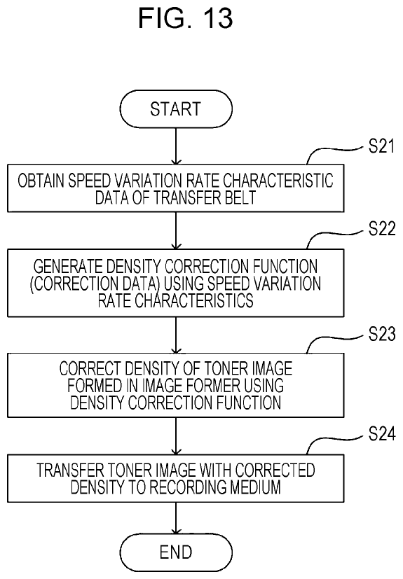

Next, the process at the time of density correction in the image forming apparatus 10 will be described with reference to the flowchart of FIG. 13.

First, in step S21, the controller 111 obtains speed variation rate characteristic data of the transfer belt 30 based on the detection signal of the rotational speed sensor 60.

Next, in step S22, the controller 111 generates a density correction function f(x) as correction data for each event using the speed variation rate characteristics of the transfer belt 30, and stores the density correction function f(x) in the storage unit 112.

Next, in step S23, when a toner image is formed on a recording medium P, the controller 111 corrects the density of the toner image formed in the image former 12 using a density correction function f(x) stored in the storage unit 112 for each event.

As described above, the density correction at this point may be made by correcting the image data to form a toner image using a density correction function f(x), or by correcting the exposure amount in the exposure device 86 of the toner image former 80 using a density correction function f(x).

Finally, in step S24, the controller 111 transfers the toner image with a corrected density to a recording medium P, and completes the process.

Although the image forming apparatus in an exemplary embodiment of the present disclosure has been described above, the present disclosure is not limited to the exemplary embodiment, and may be modified as appropriate.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Also, in the exemplary embodiment, a case has been described in which the present disclosure is applied to a printing machine having a print function, as the image forming apparatus; however, the present disclosure is not limited to this, and may be applied to various types of image forming apparatuses, for example, a multifunction printer equipped with a scanner.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An image forming apparatus comprising:
a transporter including a gripper to grip a recording medium;
an image former that forms a developer image on a transfer body;
a transferrer that brings the transfer body with the developer image formed into contact with a transfer cylinder having space to store the gripper, and transfers the developer image to the recording medium; and
a processor configured to:
   correct a density of the developer image formed in the image former, using information related to speed variation of the transfer body when the developer image is transferred to the recording medium, so that density unevenness in an image formed on the recording medium is reduced.
      (((2)))

The image forming apparatus according to (((1))), wherein the information related to speed variation of the transfer body is information based on a detection signal of a rotational speed sensor to detect a rotational speed of a component that rotates in conjunction with the transfer body in the image forming apparatus.

(((3)))

The image forming apparatus according to (((2))), wherein the information related to speed variation of the transfer body is information based on a detection signal of a rotational speed sensor to detect a rotational speed of the transfer cylinder.

(((4)))

The image forming apparatus according to (((2))), wherein the information related to speed variation of the transfer body is information based on a detection signal of a rotational speed sensor to detect a rotational speed of a rotating body that is in contact with the transfer body.

(((5)))

The image forming apparatus according to any one of (((1))) to (((4))), wherein the processor is configured to
correct a density for an area in a developer image formed in the image former using information on an occurrence start point of a phenomenon causing a speed variation and frequency of the speed variation in the information related to speed variation of the transfer body, and further using a correction function indicating a correction amount for density correction to a developer image, defined for the phenomenon, the area corresponding to a time period set since the occurrence start point of the phenomenon.
   (((6)))

The image forming apparatus according to (((5))),
wherein the correction amount for density correction in the correction function has an attenuation characteristic such that the correction amount for density correction reduces as time passes.
   (((7)))

A program causing a computer to execute a process for controlling an image forming apparatus including:

a transporter including a gripper to grip a recording medium;

an image former that forms a developer image on a transfer body;

a transferrer that brings the transfer body with the developer image formed into contact with a transfer cylinder having space to store the gripper, and transfers the developer image to the recording medium; and
a processor,
the process comprising:
   correcting a density of the developer image formed in the image former, using information related to speed variation of the transfer body when the developer image is transferred to the recording medium, so that density unevenness in an image formed on the recording medium is reduced.

What is claimed is:

1. An image forming apparatus comprising:
a transporter including a gripper to grip a recording medium;
an image former that forms a developer image on a transfer body;
a transferrer that transfers the developer image to the recording medium by bringing the transfer body with the developer image formed into contact with a transfer cylinder having space to store the gripper; and
a processor configured to:
correct a density of the developer image formed in the image former, using information related to speed variation of the transfer body when the developer image is transferred to the recording medium, so that density unevenness in an image formed on the recording medium is reduced.

2. The image forming apparatus according to claim 1,
wherein the information related to speed variation of the transfer body is information based on a detection signal of a rotational speed sensor to detect a rotational speed of a component that rotates in conjunction with the transfer body in the image forming apparatus.

3. The image forming apparatus according to claim 2,
wherein the information related to speed variation of the transfer body is information based on a detection signal of a rotational speed sensor to detect a rotational speed of the transfer cylinder.

4. The image forming apparatus according to claim 2,
wherein the information related to speed variation of the transfer body is information based on a detection signal of a rotational speed sensor to detect a rotational speed of a rotating body that is in contact with the transfer body.

5. The image forming apparatus according to claim 1,
wherein the processor is configured to correct a density for an area in a developer image formed in the image former using information on an occurrence start point of a phenomenon causing a speed variation and frequency of the speed variation in the information related to speed variation of the transfer body, and further using a correction function indicating a correction amount for density correction to a developer image, defined for the phenomenon, the area corresponding to a time period set since the occurrence start point of the phenomenon.

6. The image forming apparatus according to claim 5,
wherein the correction amount for density correction in the correction function has an attenuation characteristic such that the correction amount for density correction reduces as time passes.

7. A non-transitory computer readable medium storing a program causing a computer to execute a process for controlling an image forming apparatus including:
a transporter including a gripper to grip a recording medium;
an image former that forms a developer image on a transfer body;
a transferrer that transfers the developer image to the recording medium by bringing the transfer body with the developer image formed into contact with a transfer cylinder having space to store the gripper; and
a processor,
the process comprising:
correcting a density of the developer image formed in the image former, using information related to speed variation of the transfer body when the developer image is transferred to the recording medium, so that density unevenness in an image formed on the recording medium is reduced.

8. An image forming apparatus comprising:
means for transporting, including a gripper to grip a recording medium;
means for forming a developer image on a transfer body;
means for transferring the developer image to the recording medium by bringing the transfer body with the developer image formed into contact with a transfer cylinder having space to store the gripper; and
means for correcting a density of the developer image formed in the means for forming a developer image, using information related to speed variation of the transfer body when the developer image is transferred to the recording medium, so that density unevenness in an image formed on the recording medium is reduced.
